(19) United States
(12) Patent Application Publication
(10) Pub. No.: US 2008/0091802 A1
(43) Pub. Date: Apr. 17, 2008

(54) Plug and play scheme for IP based devices and their failover scheme for quality of services

(76) Inventor: Wen-Jea Whan, La Puente, CA (US)

Correspondence Address: TROXELL LAW OFFICE PLLC, 5205 LEESBURG PIKE, SUITE 1404, FALLS CHURCH, VA, 22041, US

(21) Appl. No.: 11/580,296

(22) Filed: Oct. 13, 2006

(51) Int. Cl. G06F 15/177

(52) U.S. Cl. 709/220

(57) ABSTRACT

A plug and play scheme for IP based devices and their failover schemes for quality of services includes establishing a infrastructure in the Internet so that the IP based devices can be plug and play in the present or oncoming Internet. Through the Dynamic IP and the Internet, a visitor can connect with an IP based device by broadcasting and send or receive information without going to through servers so that the data traffic in the Internet will be reduced. Additionally, with a plurality of the bridge servers being backup with each other, the transmission quality can be insured by means of automatic data transmission through the bridge servers if the connection between the visitor and the IP based device breaks. Furthermore, the infrastructure includes several failover ways to ensure the link between the visitor and the IP based device and reduce the risk of losing connection with the Internet.

### FIELD OF THE INVENTION

The present invention relates to a plug and play scheme for IP (Internet Protocol) based devices and their failover schemes, and more particularly, to one in a Globally centrally hosted server system to reduce data traffic by means of the Internet and Dynamic IP.

### DESCRIPTION OF THE PRIOR ART

With the progress and development in the present times, more and more equipments are used in daily lives. Moreover, with the rapid development and the maturation in computer technology and the Internet, it not only dramatically shortens the distance among people but also makes it possible to connect with various equipments in a plurality of remote sites.

A conventional centrally hosted server system, such as a centrally managed image system 2 as shown in FIG. 5, comprises a host 21 and a plurality of cameras 22 that receive the information about image and sound and then send it to the host 21 to be saved. Any user who wants to browse the information has to download it first from the host 21. Thus, the information is downloaded or uploaded all through the host 21 and within the same period of time the greater amount of the information is, the greater load the host will take. Resultantly, the jam in the Internet will occur if there is no greater capacity to handle the increasing data traffic and it will further lead to slow transmission speed and longer duration of time. However, if the cameras 22 can be connected with the terminal ends of visitors 23 pier to pier, the load of the host 21 will be reduced to achieve the best transmission state for information. In this example above, the host 21 exists independently so that if it malfunctions, the terminal ends of visitors 23 will fail to receive the information about image and sound from the cameras 22 and it will bring inconvenience and loss to visitors. Thus, for many present corporations, it is necessary to provide visitors with the Internet of high availability and constant connectivity.

It is usually impossible to obtain the exact IP addresses for all devices in the Internet to connect with each other pier to pier just because most visitors are in connection with the Internet by dynamic IP addresses provided by PPPoE or DHCP (Dynamic Host Configuration Protocol). Besides, in most present ISP corporations, the service of providing fixed IP addresses is more expensive than that of providing dynamic IP addresses. Hence, without a proper transmission mechanism in this example above, the pier-to-pier connection between the terminal ends of visitors 23 and the cameras 22 can work only when the two ends own fixed IP addresses, and this will increase the cost of the visitors. Additionally, the visitors will fail to get important information and thus suffer great loss if they cannot receive the information from the cameras 22 through the wired Internet at any moment.

Routers solve the problem about IP sharing. However, it is necessary to set the function of switching addresses before the IP based devices are in connection with routers, and thus it is very inconvenient. Therefore, the present invention provides a plug and play scheme for IP based devices and their failover schemes. The scheme makes possible the pier-to-pier connection between browsing devices and plug and play devices through any slave server under the failover to bring high availability and constant connectivity of the Internet to the visitors.

### SUMMARY OF THE INVENTION

The main objective of the present invention is to provide a plug and play scheme for IP based devices and their failover schemes wherein the IP based devices can be plug and play in the present or connected Internet.

The second objective of the present invention is to provide a plug and play scheme for IP based devices and their failover schemes wherein the IP based devices can be plug and play in the present or oncoming Internet and the visitors can connect with that devices easily.

The third objective of the present invention is to provide a plug and play scheme for IP based devices and their failover schemes wherein the visitors can directly connect to the IP based devices without going to through the central server so that the quality of the information transmission will be improved and the data traffic in the Internet will be reduced.

The fourth objective of the present invention is to provide a plug and play scheme for IP based devices and their failover schemes by which the IP based devices can be connected with each other smoothly.

To achieve the objectives mentioned above, the present invention comprises a centrally hosted server system wherein all the elements can be connected with each other to receive or send information and that system is composted of a master/slave server configuration, a plurality of IP based devices, and a plurality of visitors; the master/slave server configuration including a master server and a plurality of slave servers, and the master server can be backup by mirrors at the same site or remote sites of master server to insure the function of the master server.

The IP based device with a dynamic IP address constantly sends a registration package to a specific slave server of the system and meantime failovers to other slave servers. If the registration fails the device turns to register at other slave servers.

When the registered slave server receives the registration information, it will mirror the information to all the other slave servers.

The visitors should be the devices able to connect with the Internet. Besides, the visitors should connect with a specific slave server in the system and meantime failover to other slave servers so that they can visit the IP based devices. If the first connection with the pre-assigned slave server fails, it will turn to connect with other ones.

The server used by a visitor will inform the specific slave server about the visitor's IP information.

The IP based device sends a package back to the visitor so that the visitor can connect directly with the IP based device.

Thus, the visitor can exchange information with the IP based device without going to through any of the slave servers.

Moreover, the present invention has a plurality of bridge servers through which the information can be communicated constantly between the visitor and the IP based device if their connection fails.

Furthermore, the present invention provides a broadcasting and mutual agreement between the visitor and the IP based device so that their connection in a local network can work without going to through the Internet.

The present invention will be apparent after reading the detailed description of the preferred embodiment in reference to the accompanying drawings.

### BRIEF DESCRIPTION OF THE DRAWINGS

FIG. 1 shows the network configuration of the present invention for IP devices and visitors.

FIG. 2 is a schematic view of the present invention wherein the elements are in connection with each other to make the IP based devices plug and play.

FIG. 3 is a schematic view of the present invention wherein through the failover of the bridge servers the IP based devices are plug and play.

FIG. 4 is a schematic view of the present invention wherein the plug and play IP based devices are used in a local network.

FIG. 5 shows the network configuration of the conventional centrally hosted server system.

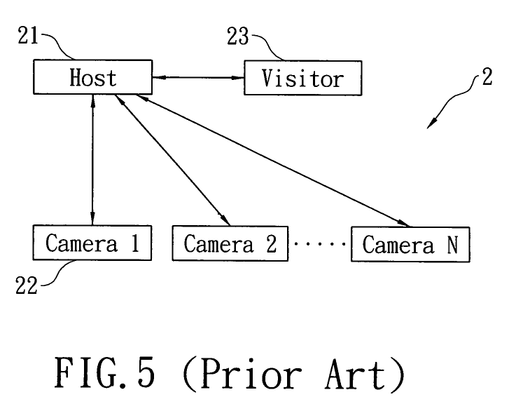

### DETAILED DESCRIPTION OF THE PREFERRED EMBODIMENT

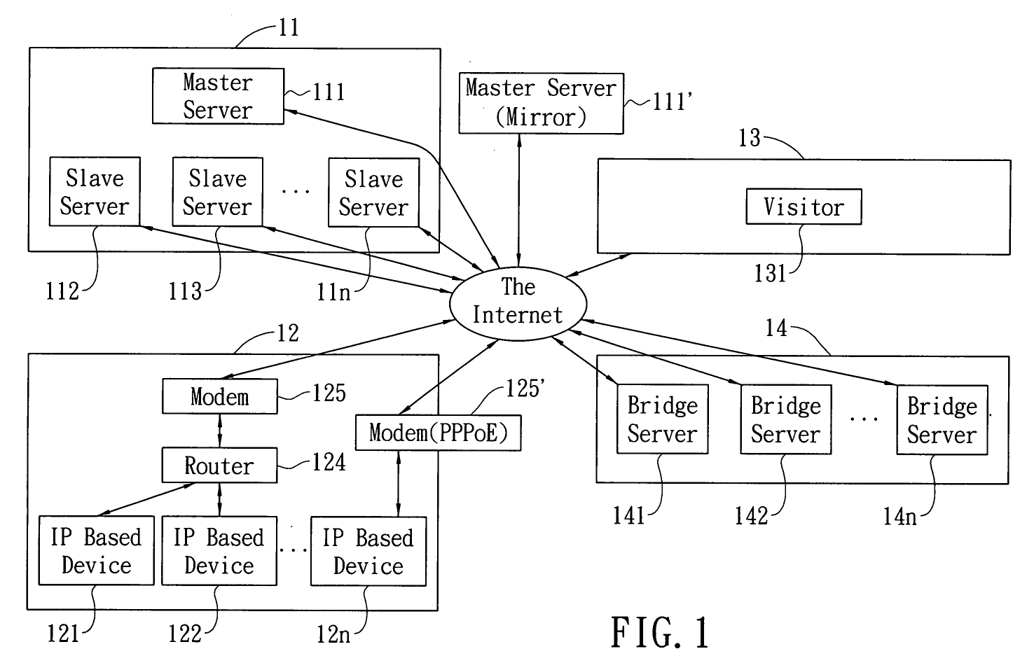

Referring to FIG. 1, the present invention establishes an infrastructure in the Internet wherein all elements can be connected with each other to transmit information. The infrastructure comprises a master/slave server configuration 11, a plurality of IP based devices (121, 122, 12n), at least one visitor 131, and a plurality of bridge servers 14, 141, 14n; wherein, the master/slave server configuration 11 is composed of a master server 111 and a plurality of slave servers 112, 113, 11n, and the master server 111 manages the slave servers 112, 113, 11n and can be backup by mirrors 111′ at the same site or remote sites of master server 111 to insure the function of the master server 111. A plurality of the IP based devices (121, 122, 12n) is connected with a router 124 and the Internet through a modem. The router 124 can be, but not limited to, the Hub, the Ethernet Switch or the Wifi Access Point; and the modem 125 can be replaced by various standards of xDSL (Digital Subscriber Line), PSTN (Public Switched Telephone Network), Cable, GPRS (General Packet Radio Service), or Xcdma (X-Code-Division Multiple Access). Besides, the IP based devices (121, 122, 12n) can be in direct connection with the Internet through a modem 125′ by means of PPPoE.

A plurality of the IP based devices (121, 122, 12n) can be, but not limited to, the PC (personal computers), Pocket PC, IP phones, SetTopBox, IP Cameras, Video Gateways, or Mobile Phones. The visitors 131 can be, but not limited to, the PC, Pocket PC, IP phones, SetTopBox, IP Cameras, Video Gateways, or Mobile Phones. The system further should be pre-installed a initialization flow procedures and a plurality of failover procedures so that the IP based devices can be plug and play and connected with other elements for the failover purpose.

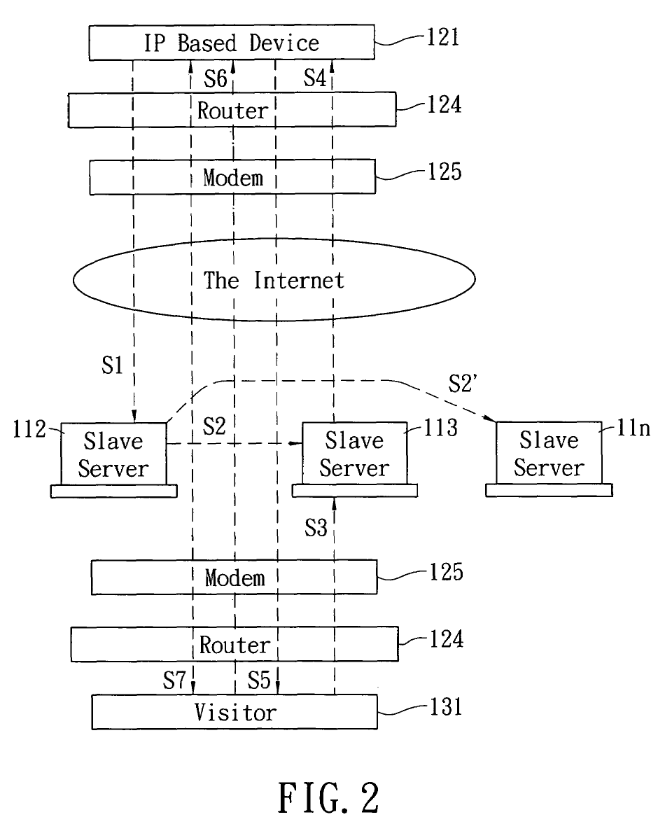

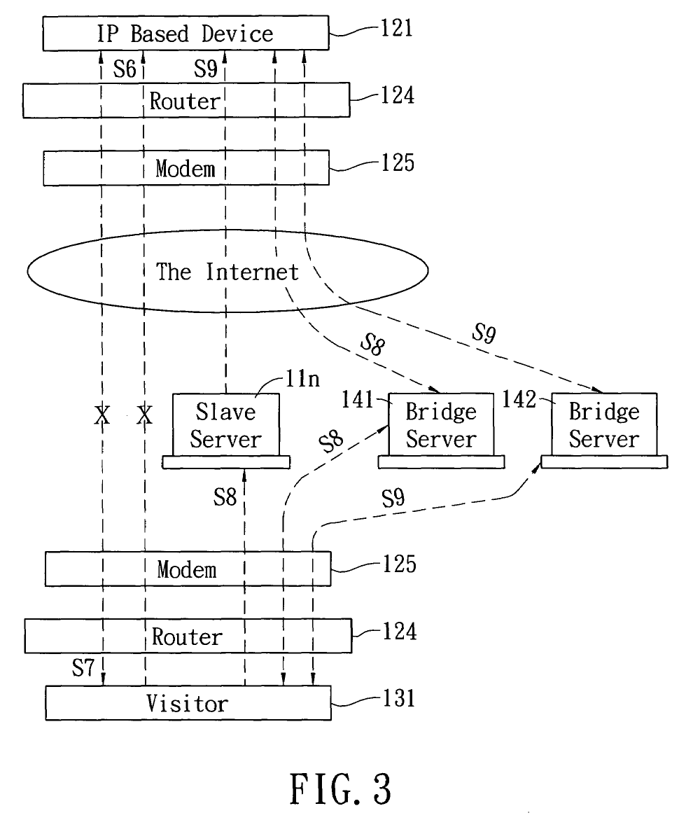

Therein, the IP based device constantly sends a registration package with the information about IP addresses, port number, or other basic information to a specific slave server in the system. While connecting with and registering at the slave server, the IP based device also failovers to other ones so that the device can register at other slave servers when the former registration fails. The registered slave server received the information of the IP based device will mirror the information to all the other slave servers. The visitor visits a specific slave server in the system and failovers to others to connect with the IP based device, and if the first connection with the pre-assigned slave server fails, the connection will be routed to other slave servers automatically. The specific slave server informs the slaver server registered by the IP based device about the information of the visitors' IP. Then the IP based device sends a package to the visitor so that the visitor can directly connect with the IP based device and meantime failover to the bridge servers; if the connection mentioned above fails, the visitor and the IP based device can exchange information with each other through the bridge servers. Referring to FIG. 2 and 3 will make apparent the connection procedures among the elements in the present invention.
S1. The IP based device registers at the slave server.
S2. The slave server registered failovers to other slave servers.
S3. S4. The visitor detects the IP based device from any slave server.
S5. The IP based device sends a package to the visitor.
S6. The visitors directly connect with the IP based devices without going to through slave servers.
S7. The visitor exchanges the information directly with the IP based device.
S8. When the connection between the visitor and the IP based device fails, the two exchange the information by means of the pre-assigned bridge servers instead.
S9. If the transmission through the bridge servers breaks, the information will be sent through the failover bridge servers instead.

Moreover, the bridge servers can be added to ensure the connection quality between the visitor and the IP based device.

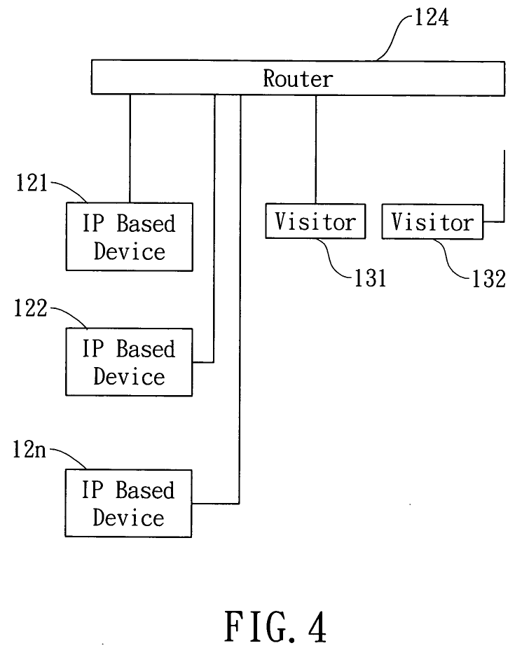

Referring to FIG. 4, if the visitors and the IP based devices are in the same local network, the visitors can automatically detect the IP addresses of the IP based devices by means that the IP based devices broadcast and thus the devices can be plug and play in this local network. Referring still to FIG. 4, the IP based devices 121, 122, 12n and the visitors 131, 132 are all connected with the same router 124 that can be, but not limited to, the Hub, the Ethernet Switch or the Wifi Access Point.

Whether the present invention is used in a local network or not, the IP based devices can be plug and play.

Therefore, the present invention has the following advantages:
1. The initialization flow procedures render the IP based device plug and play in the present or oncoming Internet and these device does not need to be pre-set.
2. The initialized information can be transmitted to and fro between the visitor and the IP based device without going to through the servers and only a bit of information has to be sent through pre-assigned servers.
3. The visitor can find the pre-assigned slaver server for the IP based device through any of the slave servers, and then get the pertinent information about the IP based device from the pre-assigned slaver server. Thus the visitor can connect with the IP based device directly.
4. If the connection procedures mentioned above fails, the present invention further provides the bridge servers to failover and thus maintain the connection between the visitor and the IP based device.
5. Through the method provided by the present invention, the visitor can automatically connect with the IP based device. Besides, the information transmission between the two is highly efficient and thus the present invention is of industrial use.

1. A plug and play scheme for IP based devices and their failover schemes for quality of services including steps of:
establishing a centrally hosted server system, wherein all the elements can be connected with each other to receive or send information, and the system including a master/slave server configuration, a plurality of IP based devices, and a plurality of visitors; wherein, the master/slave server configuration includes a master server and a plurality of slave servers, and the master server can be backup by mirrors at the same site or remote sites of master server to insure the function of the master server;
the IP based device sending a registration package constantly to a specific slave server and meantime failovering to other slave servers;
the registered slave server receiving the information about the IP based device and mirroring it to all the other slave servers;
the visitor visiting a specific slave server in the system and meantime failovering to other slave servers so that the visitor can connect with the IP based device;
the slave server informing the slave server registered by the IP based device about the information of the visitor's IP;
the IP based device sending a package to the visitor; and
the IP based device rendering the visitor able to be in direct connection with it;
the IP address of the IP based device being obtained by the visitor through any of the slave servers and then making possible the connection and the information exchange between the visitor and the IP based device.

2. The plug and play scheme for IP based devices and their failover schemes for quality of services as in claim 1, wherein the present invention further including at least one bridge server so that if the connection between the visitor and the IP based device fails both of the visitor and the IP based device will be informed through the bridge server (First Failover Bridge Server).

3. The plug and play scheme for IP based devices and their failover schemes for quality of services as in claim 2, wherein when there is a plurality of the bridge servers, the system further includes failover procedures used among a plurality of the bridge servers (Consecutive Failover Bridge Servers) to insure the information exchange between the visitor and the IP based device.

4. The plug and play scheme for IP based devices and their failover schemes for quality of services as in claim 1, wherein the system further includes Consecutive Failover infoServers for Devices.

5. The plug and play scheme for IP based devices and their failover schemes for quality of services as in claim 1, wherein the system further includes Consecutive Failover infoServers for Visitors.

6. The plug and play scheme for IP based devices and their failover schemes for quality of services as in claim 1, wherein at least one of a plurality of the IP based devices can be as a visitor.

7. The plug and play scheme for IP based devices and their failover schemes for quality of services as in claim 1, wherein a plurality of visitors can be any of devices able to be in connection with the Internet.

8. The plug and play scheme for IP based devices and their failover schemes for quality of services as in claim 7, wherein the devices able to be in connection with the Internet can be the PC, Pocket PC, IP phones, SetTopBox, or Mobile Phones.

9. The plug and play scheme for IP based devices and their failover schemes for quality of services as in claim 1, wherein a plurality of the IP based devices can be the PC, Pocket PC, IP Phones, SetTopBox, IP Cameras, Video Gateways, or Mobile Phones.

10. The plug and play scheme for IP based devices and their failover schemes for quality of services as in claim 1, wherein a broadcasting and mutual agreement between the visitor and the IP based device exists in a local network so that the connection between the two can work without going to through the Internet to insure the plug and play use in the local network.

11. The plug and play scheme for IP based devices and their failover schemes for quality of services as in claim 6, wherein a plurality of visitors can be any of devices able to be in connection with the Internet.

12. The plug and play scheme for IP based devices and their failover schemes for quality of services as in claim 11, wherein the devices able to be in connection with the Internet can be the PC, Pocket PC, IP phones, SetTopBox, or Mobile Phones.
